(19) United States
(12) Patent Application Publication
(10) Pub. No.: US 2011/0011466 A1
(43) Pub. Date: Jan. 20, 2011

(54) Deflator

(76) Inventor: Anthony Joseph Morrone, II, Hilo, HI (US)

Correspondence Address: Anthony J. Morrone II, 2400 Kinoole Street, Hilo, HI, 96720, US

(21) Appl. No.: 12/460,389

(22) Filed: Jul. 16, 2009

(51) Int. Cl. F16K 15/20

(52) U.S. Cl. 137/231

(57) ABSTRACT

A relatively thin, rectangular shaped device with a semi-circle attachment ring. The device contains a slot in its face, which slot narrows as it reaches the center of the rectangle so that when it engages the valve stem of a cut-check valve, the valve is deformed without damage a sufficient degree so that the cut-check valve is unseated, allowing air to pass either way through the cut-check valve. The attachment ring can be secured to the product being deflated for storage and future use.

This invention relates generally to a device to allow deflating of inflatable objects equipped with cut-check valves. The cut-check valve is widely used in the manufacture of inflatable toys, swimming pool floats, air mattresses, rafts, promotional products, etc. This valve is a single tube of suitable pliant material, such as plastic or rubber, with one end open and the other end closed. The check valve is accomplished by cutting a slit, approximately one-half the diameter of the tube, in the wall of the tube near the closed end, which end extends inside the surface of the inflatable.

The cut-check valve must be opened in order for air to freely enter or escape from the inflatable. Prior to this invention, individuals were left with no practical commercial product that this invention addresses. Deflation of products having cut-check valves have been done manually, requiring at least one hand to squeeze the valve to release the air. This process is cumbersome and time consuming.

This invention eliminates this problem of securing the invention to the cut-check valve. Previous attempts utilized curved and smooth edges to secure the tool. This proved to be problematic. The force of the released air would dislodge the tool from the base of the cut-check valve because, the edges provided no resistance. This problem has been resolved with the inclusion of serrated edges. These edges securely hold the invention in place until the product has been totally deflated.

Additionally, prior to this invention, individuals had no way to attach a deflation tool to the inflatable. This innovation, substantially enhances all prior attempts in development of a practical tool that can be easily retrieved for later use. This has been achieved by incorporating an attachment semi-circle into the body of this invention.

Applicant performed a patent search to determine what methods of accomplishing his objectives were known and the result of the search disclosed two devices to accomplish the same objective. There were two devices addressing the inventor's objectives: U.S. Pat. Nos. 5,007,449 and, 5,862,845. The prior art depicts to radically different approaches to releasing the air. This invention seeks to accomplish what U.S. Pat. No. 5,007,449 was intended to accomplish through innovation & a radically redesigned preferred embodiment.

The object of this invention is accomplished by its preferred embodiment, a polystyrene device in the shape of a rectangular air mattress. Approximately two and one-half inches in length, with a polystyrene semi-circle attached to the non-slotted end of proportional size. The opposite end of said device has a slot which tapers at a fixed rate towards the attachment end at a proportional rate that allow for the securing of said device to wide array of differently sized cut-check valves. The slot of said embodiment is slid around the stem of the valve which protrudes from the surface of the inflatable until the stem deforms a sufficient amount so as to unseat the base of the cut-check valve inside the inflatable. The edges of the preferred embodiment are serrated to a sufficient degree to hold said device in place without damaging the valve. The device is securely held in place until the transfer of air is complete.

### BRIEF DESCRIPTION OF THE DRAWINGS

FIG. 1 is a plan view of the cut-check valve as installed on the surface of an inflatable.

FIG. 2 is a plan view of the invention; and

FIG. 3 is a frontal view showing the invention engaging the stem of the cut-check valve.

### DESCRIPTION OF PREFERRED EMBODIMENTS

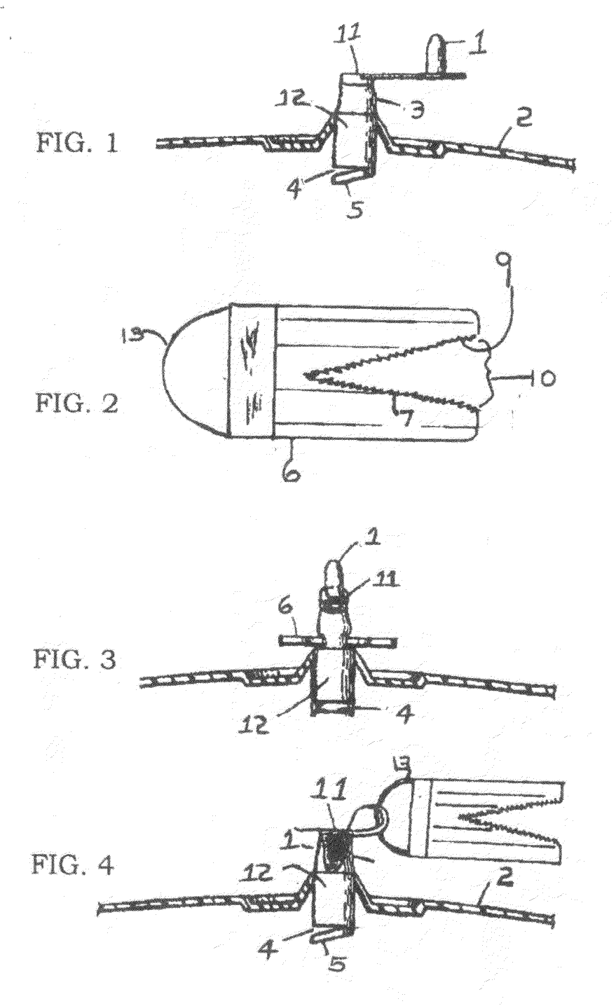

With reference to the drawings, FIG. 1 shows a standard cut-check valve assembly as installed on the surface of an inflatable (2). The cut-check valve assembly is composed of a hollow tube (12) of uniform diameter and made of a suitable pliable material such as rubber or plastic. The end of the tube (12) which protrudes above the surface of the inflatable (2), referred to as the valve stem (3), has an end which is open (11), equipped with a stopper cap(1), that is removable affixed to the top of the tube (12). The end of the tube (12), which extends into the inside of the surface of the inflatable (2), is closed, but a short distance from the closed end, referred to as the valve seat (5), there is a slit cut perpendicular into the wall of the hollow tube (12), said slit penetrating as least one-half of the diameter of the hollow tube (12), which is the cut-check valve (4).

When air is forced through the open end of the tube (11), it pushes against the valve seat (5), which rotates to open the cut-check valve (4). As the air pressure within the inflatable rises, the valve seat (5), exerts more and more resistance to the air flow from the open end of the tube (11), and tries to close the cut-check valve (4). When the desired air pressure is reached inside the inflatable, the stopper cap (1) is inserted into the open end of the tube (11).

When it is desired to deflate the inflatable, the stopper-cap (1), is removed from the open end of the tube (11). However, due to the pressure of the air within the surface of the inflatable (2), acting against the valve seat (5), the cut-check valve (4), tends to close, thus making it difficult to rapidly force the air out of the inflatable.

FIG. 2 illustrates a preferred embodiment of the invention. The embodiment is an rectangular shape resemembling an air mattress, with an attachment ring (6), of suitable material, such as polystyrene, being of suitable length, width, and rigidity to accommodate the valve stem (3) of an inflatable within the slot (7), cut into its body and converging at a constant rate to its base (8), just Beyond its center, so as to be approximately one-half the diameter of the valve stem (3), at its narrowest point and comfortable wider than the diameter of the valve stem (3), at its mouth (10). The edges of the slot (9), and its base (8), just beyond its center, so as to be approximately one-half the diameter of the valve stem (3), at its narrowest point and comfortably wider than the diameter of the valve stem (3), at its mouth (10). The edges of the slot and its base (8), are serrated (9), so as to maintain the device securely during the deflation process, without damaging the surface of the inflatable, or the valve stem (3).

In order to hold the cut-check valve open, the mouth of the slot (10), of the invention is slid around the valve stem (3), and the invention is moved passed the valve stem (3), so that the valve stem (3), is drawn toward the narrow end of the slot near the base (8). The sides of the slot (7), compress the walls of the valve stem (3), as shown in FIG. 3, which results in changing the shape of the entire length of the hollow tube (12), so that the valve seat (5), no longer closes the cut-check valve (4).

Thus the invention holds open the cut-check valve assembly allowing the person desiring to deflate the inflatable to use both hands to fold or compress the inflatable in a much faster manner or, simply to walk away and let the invention release the air.

In order to make the invention have easy access for future uses, the inventor has added a semi-circle, half ring (13), that has now been incorporated onto the body of the device in FIG. 4. After use, for storage, and future usage, the invention can now be attached to the inflatable (2), by passing the attachment ring (13), over the stopper valve (1). By simply inserting the stopper cap (1) into the open end of the tube (11), the device can be stored for future use.

The scope of the invention disclosed herein is found by reference to the following claims.

I claim:

1. A deflating tool for use in conjunction with cut-check valves, being constructed of suitable rigid material having a slot in its body of suitable length and width which tapers from the perimeter of the tool at a suitable fixed rate so as to accommodate the stem of the cut-check valve at its widest part and squeeze the valve stem, without damaging it, as the slot is moved passed the stem, so that the stem deforms a sufficient amount to open the cut-check valve, said surface of the deflating tool slot being finished with a serrated edge to hold the invention securely without damaging the valve stem.

2. The deflating tool of claim 1 in which the suitable rigid material from which it is constructed is polystyrene and made in the general shape of an air mattress, with attachment ring Having the dimensions of approximately two and three-quarters in length, one and one-quarter inch wide, and one-quarter inch thick.

3. The deflating tool of claim 1 wherein the slot tapers at a fixed rate from the perimeter of the tool to accommodate a wide array of cut-check valve sizes.

4. The deflating tool of claim 1 wherein a proportional, semi-circle attachment ring allows the invention to be attached to the inflatable for storage and future use.

5. The deflating tool of claim 1 wherein the edges and base of the slot are serrated or otherwise configured to secure the invention while deflating or inflating.
